(19) United States
(12) Patent Application Publication
(10) Pub. No.: US 2010/0264658 A1
(43) Pub. Date: Oct. 21, 2010

(54) POWER STATION ON A SUBMERGED FLOATING PLATFORM

(76) Inventor: Manuel TORRES MARTINEZ, PAMPLONA (Navarra) (ES)

Correspondence Address: LUCAS & MERCANTI, LLP, 475 PARK AVENUE SOUTH, 15TH FLOOR, NEW YORK, NY, 10016, US

(21) Appl. No.: 12/763,728

(22) Filed: Apr. 20, 2010

(30) Foreign Application Priority Data
Apr. 20, 2009 (ES) P200901019

(51) Int. Cl. F03B 13/22; F03D 9/00; F03B 13/10

(52) U.S. Cl. 290/53; 290/55; 290/54

(57) ABSTRACT

The invention relates to a power station on a submerged floating platform consisting of a floating structure (1) submerged at a certain depth, where it is moored by means of guy lines (2) with respect to ballasts or mooring buoys (3) located in the aquatic bed, arranging on said floating structure (1) hydraulic pumping mechanisms (5) which are operated by the weight differential of the water column between the crests and the troughs of the waves when such waves pass over them, in combination with a pneumatic system acting as a spring in said mechanisms (5) for operating an electricity-generating turbine (8) through a hydraulic closed circuit.

### FIELD OF THE ART

The present invention relates to the exploitation of renewable energies for producing electricity, proposing a power station which is built on a submerged floating platform, with an embodiment that allows exploiting the energy potential of the movements of the water and of the wind.

### STATE OF THE ART

For producing electric power by means of exploiting wind energy, the proliferation of offshore wind farms in shallow water, with piling on the aquatic bed where greater and less gusty wind conditions are obtained than on land due to the scarce roughness of the surface of the water, is known.

Recent tests are also known in which floating or submerged buoys are used for obtaining electric power by means of exploiting the energy content of the movements of water.

In this sense systems of pontoons are known for obtaining energy from water waves, by means of pontoons arranged on the surface of the water, which follow an alternating movement between the position on the crests and the position on the troughs of the waves, such that the higher the wave, the greater the alternating travel of the pontoons and therefore the more energy can be obtained.

Systems based on a concept of submerged pontoons using the pressure differential exerted on the submerged pontoon by the water column difference between the crest and the trough of the waves in the passing of said waves on the pontoon, are also known.

Foundation concepts for offshore wind farms in deep water have furthermore been developed recently, based on the experience of offshore oil platforms secured by means of ballasts or mooring buoys anchored and joined to the floating platform by means of chains or lines.

The challenge of renewable energies is to significantly reduce the installation costs in order to achieve a cost-effective production that makes them competitive in comparison with traditional energy sources.

### OBJECT OF THE INVENTION

According to the invention, a power station having aquatic installation in deep water is proposed, with an embodiment which allows exploiting in advantageous conditions the energy force of the movements of the water and of the wind.

This power station object of the invention consists of a polygonal-shaped floating structure made up of consecutively joined tubular sectors, said structure being moored at a certain depth by means of pre-tensioned lines with respect to ballasts or mooring buoys supported on the aquatic bed, whereas pumping mechanisms which are actuated by the action of the waves when they pass over such mechanisms are arranged on this submerged floating structure, said mechanisms having a pneumatic system acting as a spring in combination with the action of the waves, while connected with these mechanisms there is arranged a hydraulic supply system of an electricity-generating turbine located above the surface of the water.

The tubular sectors of the floating structure are closed at one end, such that in the formation of the structure said sectors form isolated independent enclosures, these enclosures having valves that allow filling them with water and emptying them for mounting the floating structure in the submerged position, where it is later maintained, against flotation, by the mooring on the pre-tensioned guy lines with respect to the anchored ballasts or mooring buoys.

The pumping mechanisms consist of a dome which is joined along the contour by means of a flexible membrane with respect to a housing body, there being a chamber which is connected to the pneumatic spring system between them, whereas integral with the dome there is a plunger moving inside a cylinder connected by means of inlet/outlet valves with respect to the hydraulic supply system of the electricity-generating turbine.

The hydraulic supply system of the electricity-generating turbine is determined according to a closed circuit which passes over the pumping mechanisms and is arranged through pipes acting as circulation conduits and structural support columns of a platform in which the electricity-generating turbine is arranged, water that is desalinated and treated with corrosion controlling products being included in said closed circuit.

A wind generator can be arranged on the assembly thus formed, mounted on the platform for incorporating the electricity-generating turbine, whereas complementary propeller-type devices can be incorporated in the outer part of the floating structure.

With it a functional assembly is obtained which allows exploiting, by means of the pumping mechanisms, the energy of the water waves to operate the electricity-generating turbine, while at the same time by means of the complementary propeller-type devices, it allows exploiting the energy of the water currents for another operation to produce electricity, and by means of the wind generator arranged on the structural assembly it allows at the same time exploiting the force of the wind for the same function of producing electricity, using structurally installed elements for managing electricity which are common for the three power generation systems.

The hydraulic station can be arranged in connection with other similar stations by means of connecting walkways for walking between the different hydraulic stations without needing shuttle crafts, the power transmission lines being able to be installed on the mentioned walkways without needing underwater lines, which must be much longer and are more expensive to install.

Therefore, the proposed hydraulic station has certainly advantageous features, having its own identity and preferred character for the power production function in aquatic installations for which it is intended.

### DESCRIPTION OF THE DRAWINGS

FIG. 1 shows a schematic perspective view of a power station according to the invention in an embodiment for producing electricity only by the action of the water waves.

FIG. 2 is a plan view of the power station installation of the previous figure.

FIG. 3 is a perspective view of a tubular element forming the floating structure of the power station according to the invention.

FIG. 4 is a longitudinal section view of said tubular element of the previous figure.

FIG. 5 is a perspective view of the floating structure of the power station according to a formation example.

FIG. 6 is a detailed cross-section view of the formation and arrangement of the hydraulic pumping mechanisms of the power station of the invention.

FIG. 7 is a side view of the power station of FIG. 1, with the floating structure in cross-section.

FIG. 8 is another side view of the power station from at observation at ninety degrees with respect to the previous figure.

FIG. 9 is an enlarged detail view of area IX indicated in FIG. 7.

FIG. 10 is an enlarged detail view of area X indicated in FIG. 8.

FIG. 11 is an enlarged detail view of area XI indicated in FIG. 8.

FIG. 12 is a perspective view of a power station according to the invention with a wind generator and complementary devices operated by water currents.

FIG. 13 is a perspective view of an aquatic farm with two groups of power stations joined by means of walkways.

FIG. 14 is a perspective view of an aquatic farm of power stations joined by means of walkways, with wind generators in some of the power stations and not in others.

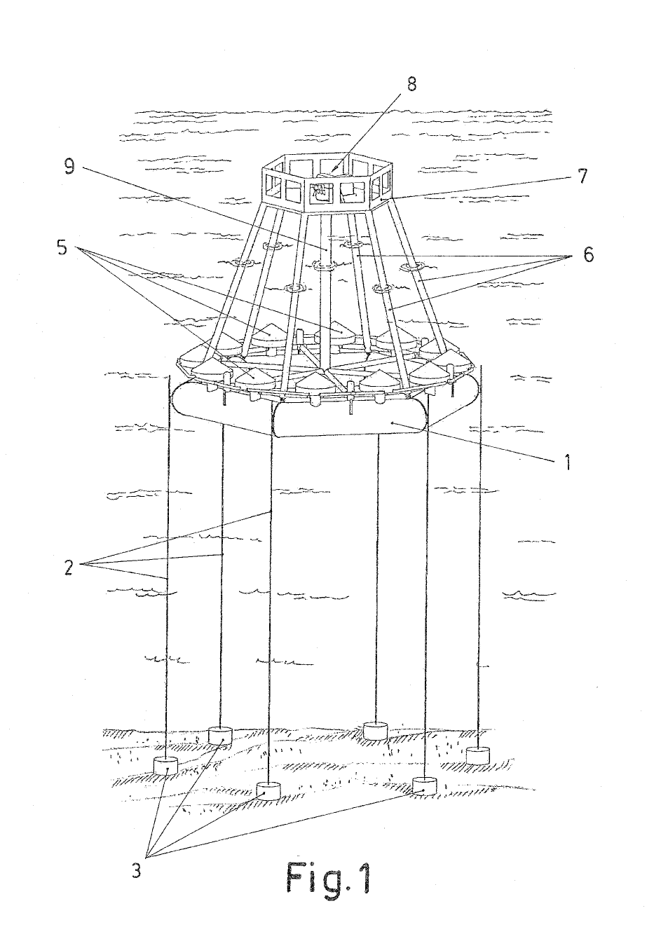

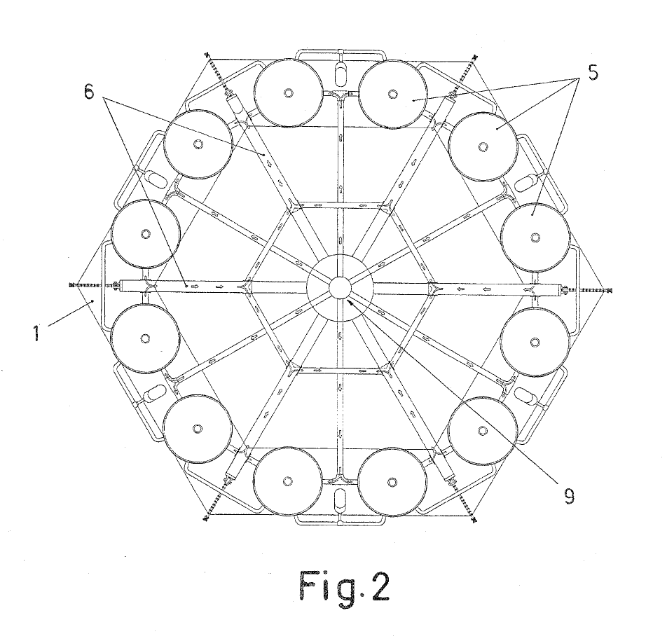

### DETAILED DESCRIPTION OF THE INVENTION

The object of the invention relates to a power station intended for an aquatic installation in deep water, with an embodiment that allows exploiting the action of water waves for an operation of producing electricity, as well as exploiting the water currents and wind currents for complementary operations of the same function of producing electricity.

The proposed power station is formed by a floating structure (1) which is submerged at a certain depth, being moored by means of pre-tensioned lines (2) with respect to ballasts or mooring buoys (3) placed in the aquatic bed, such that said lines (2) retain the floating structure (1) against flotation thereof, being tensioned in an anti-fatigue arrangement.

The lines (2) are provided with carbon fiber or fiberglass, whereby they are resistant to corrosion, the floating structure (1) being provided with reinforced concrete, thereby resulting in suitable performance against compression and also resistant to corrosion.

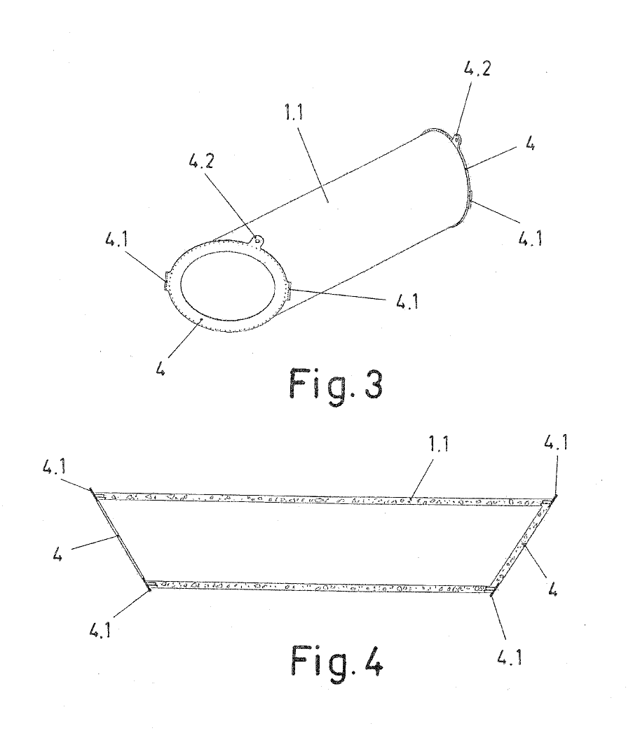

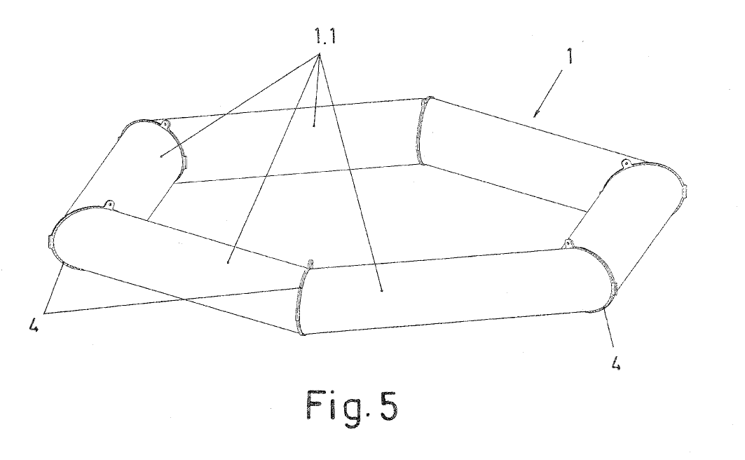

According to a particular non-limiting embodiment, the floating structure (1) has an annular polygonal shape formed by a series of consecutively joined sectors (1.1), as can be seen in FIG. 5, each of the sectors (1.1) being formed by a tubular element with beveled ends, as can be seen in FIGS. 3 and 4.

Said sectors (1.1) making up the floating structure (1) incorporate at each of the ends a flange (4), by means of which a leak-tight joint can be formed between the consecutive sectors (1.1), said flanges (4) constituting formations (4.1) for mooring the lines (2) on the floating structure (1) and formations (4.2) for mooring the upper structure forming the power station.

The mentioned sectors (1.1) of the floating structure (1) are furthermore closed at one end, such that in joining them to one another they form an assembly of independent enclosures, incorporating valves which allow them to fill with water in order to submerge the floating structure (1) to the installation depth, where it is moored to the guy lines (2), the water then being extracted from the sectors (1.1), whereby the flotation of the floating structure (1) exerts an upward force giving the lines (2) anti-fatigue tension, keeping the floating structure (1) in a stable arrangement.

Incorporated on the floating structure (1) there are hydraulic pumping mechanisms (5) in relation to which there is arranged a structural assembly formed by tubular columns (6) connected with said mechanisms (5) which support, in the upper part above the surface of the water, a platform (7) in which there is arranged an electricity-generating turbine (8) with respect to which the mentioned tubular columns (6) form a hydraulic supply with closed circuit return through a manifold (9).

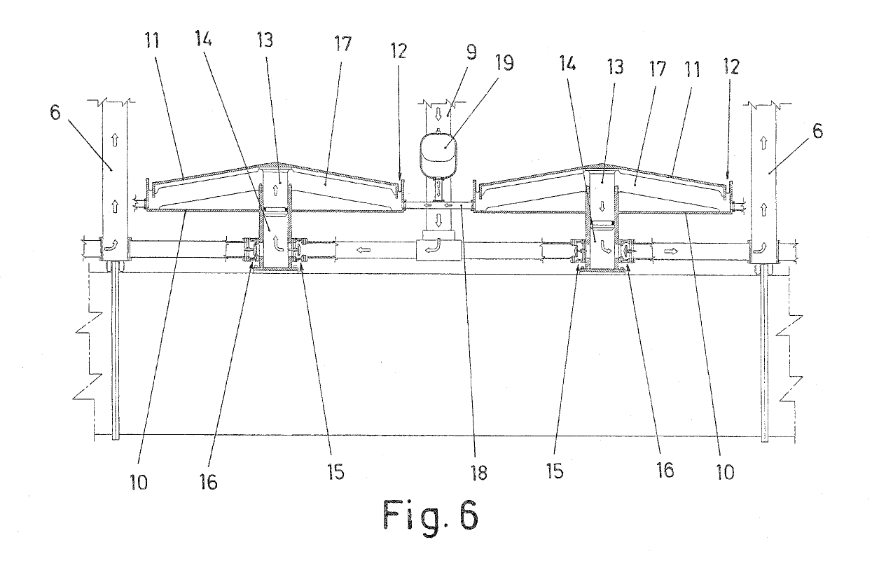

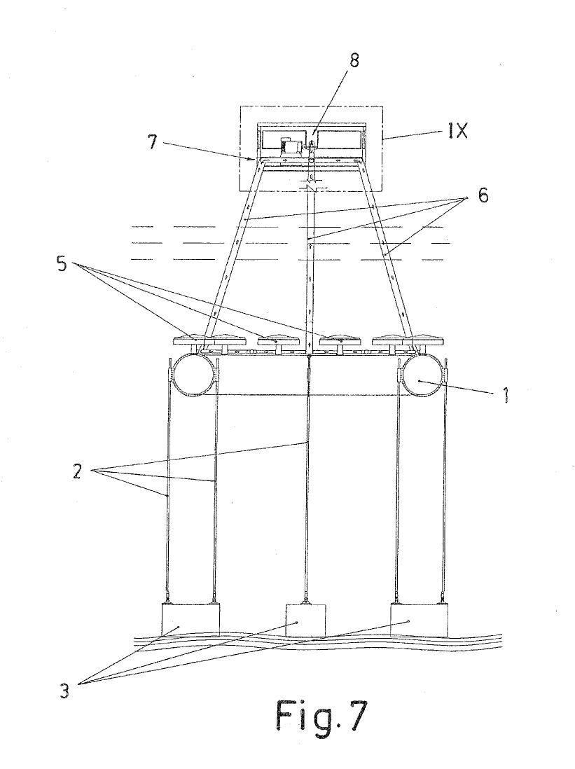

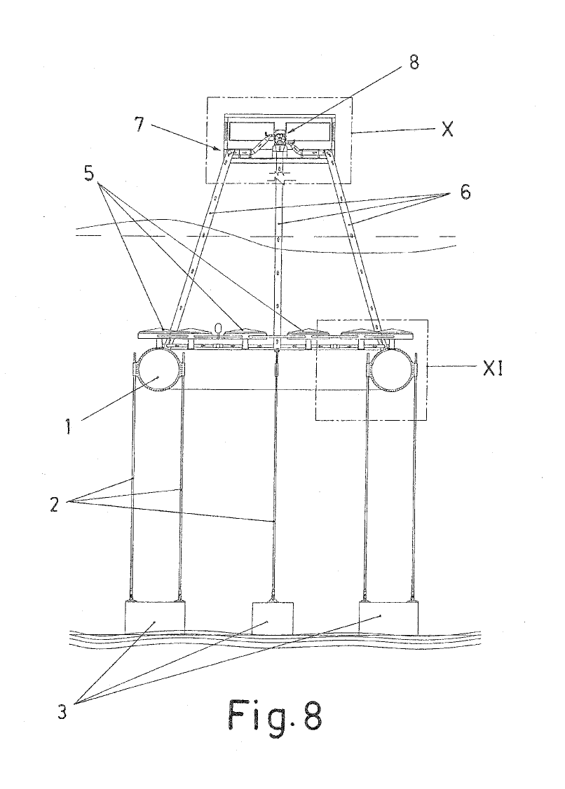

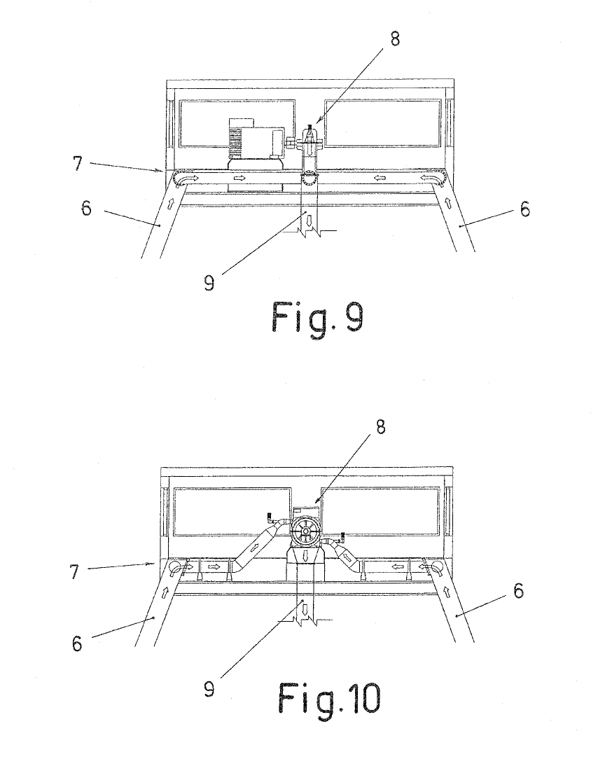

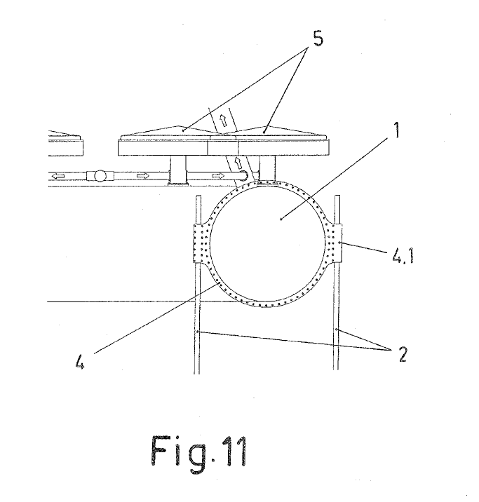

As can be seen in FIG. 6, the hydraulic pumping mechanisms (5) consist of a cylindrical body (10) in relation to which there is arranged in the upper part a dome (11) which is joined at the periphery to the body (10) by means of a flexible membrane (12), the dome (11) incorporating integral therewith a plunger (13) moving axially in a cylinder (14) with respect to which the manifold (9) and the tubular columns (6) are connected, by means of an inlet valve (15) and an outlet valve (16), respectively.

A closed circuit through the tubular columns (6) and the manifold (9) is thus defined between the cylinder (14) of the pumping mechanisms (5) and the electricity-generating turbine (8), water that is desalinated and treated with corrosion controlling additives being included in said circuit.

Between the body (10) and the dome (11) of each pumping mechanism (5) there is also defined a chamber (17) with respect to which there is connected a pneumatic system acting as a spring for pushing the dome (11) upward, said pneumatic system being communicated with the chambers (17) of all the pumping mechanisms (5) by means of connecting conduits (18) between the chambers (17) thereof, with a buffer tank (19) to compensate the pressure among the different mechanisms (5).

Therefore, as a result of the submerged arrangement of the floating structure (1) on which the pumping mechanisms (S) are placed, such mechanisms receive at the upper part a variable push due to the difference of the water column between the crests and the troughs of the waves when said waves pass over said mechanisms (5), such that this variable downward pushing action by the effect of the waves, in combination with the upward spring action by the pneumatic system acting inside the mentioned mechanisms (5) actuates the dome (11) of said mechanisms (5) in alternating vertical movements.

With this action, when the dome (11) of each mechanism (5) moves upward when the trough of a wave passes over it, an absorption occurs in the corresponding cylinder (14) causing the inlet valve (15) to open and the outlet valve (16) to close, the cylinder (14) of the closed circuit filling with Water; whereas when the dome moves downward when the crest of a wave passes over it, a pressure increase occurs in the cylinder (14) causing the outlet valve (16) to open and the inlet valve (15) to close, whereby the water contained in the cylinder (14) is expelled, thus causing alternating absorption and impulsion, circulating the water contained in the closed circuit which, when it passes over the electricity-generating turbine (8), actuates the operation thereof.

Given the displacement movement of water waves, as well as the successive sequence of such waves, their action on the different pumping mechanisms (5) of the power station is successive, actuating said pumping mechanisms (5) with synchronized alternation, like a camshaft, continuously operating the electricity-generating turbine (8).

The platform (7) incorporating the electricity-generating turbine (8) is provided with a cabin-type structure, like an engine room, being arranged above the surface of the water at a height at which it is out of reach of the waves, for housing the electricity-generating turbine (8) and the functional mechanisms of the power station, the upper part of said platform (7) being able to be formed as a heliport for the necessary transport of people and loads in relation to the power station.

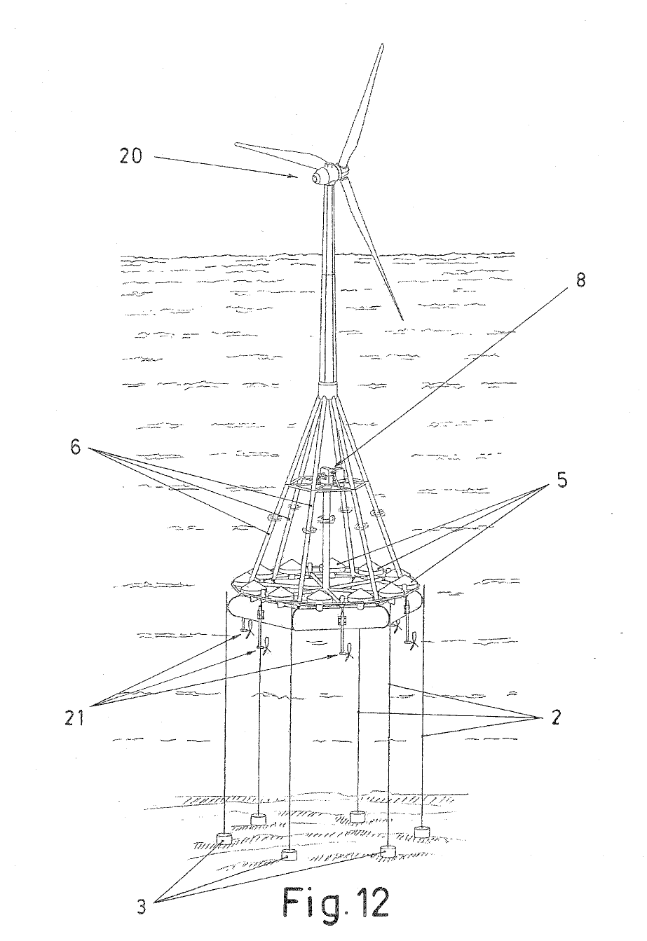

In the concept of producing electricity, which is the purpose of the power station, to complement the production provided by the turbine (8) due to the operation by means of the hydraulic pumping mechanisms (5), there can be arranged on the platform (7) a wind generator (20), as can be seen in FIG. 12, whereby the wind energy can also be exploited to produce electricity on the same structural installation for producing electricity by the waves and using the same means for managing the electricity produced.

Likewise, as can be seen in FIG. 12, there can be incorporated in the submerged structural assembly, for example on the outer part of the floating structure (1), complementary propeller-type devices (21) by means of which the movement of the water currents can be exploited for a complementary production of electricity with these complementary devices (21).

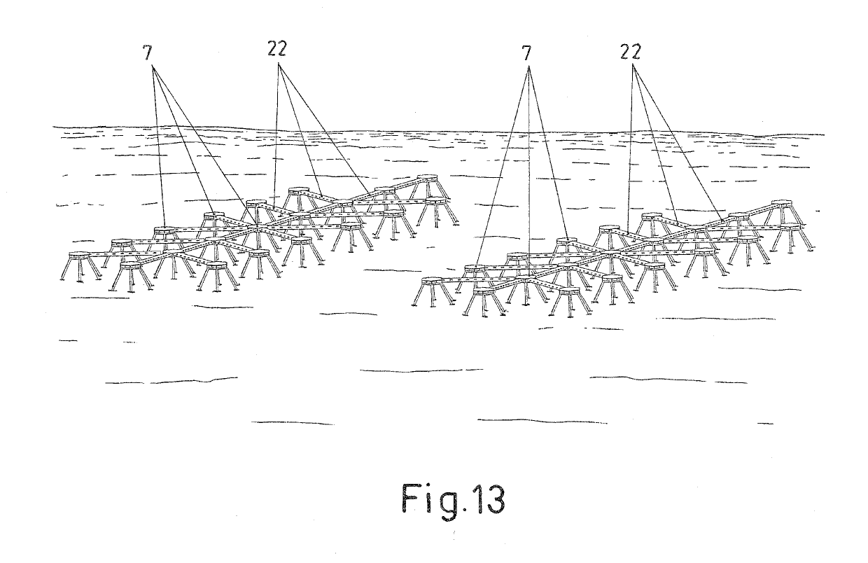

The structural assembly of the power station can furthermore be joined with other similar power stations by means of walkways (22) arranged between the corresponding platforms (7), as can be seen in FIG. 13, thus forming a farm assembly in which it is possible to walk over the walkways (22) between the different power stations, without needing aquatic vehicles, simplifying the shuttling necessary for maintenance or any other type of operations.

Said arrangement also allows placing the power transmission lines on the walkways (22), the need for much longer and much more difficult to install underwater lines thus being avoided.

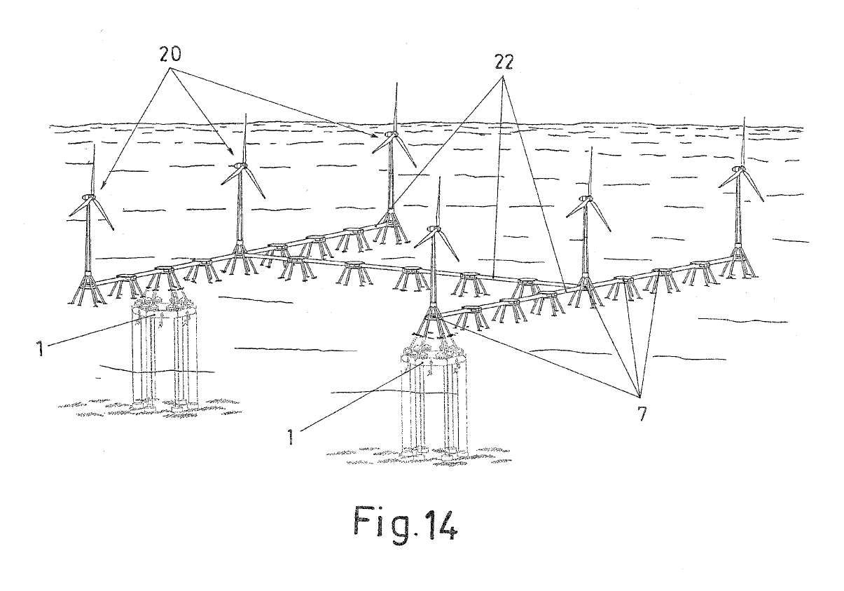

In this arrangement of multiple power stations joined by means of walkways (22), wind generators (20) can be arranged in some of the power stations and not in others, as can be seen in FIG. 14, in order to respect the necessary distance between the generators (20) for the purpose of preventing interferences and the wind breaker shield effect between them.

1. A power station on a submerged floating platform, of the type comprising a functional assembly incorporated in a floating structure submerged at a certain depth and moored by means of guy lines with respect to ballasts or mooring buoys located in the aquatic bed, characterized in that it consists of a submerged floating structure (1) on which there are arranged multiple hydraulic pumping mechanisms (5) which can be actuated by the weight differential of the water column between the crests and the troughs of the water waves when such waves pass over them, in combination with a pneumatic system acting as a spring in the mechanisms (5) themselves, said pumping mechanisms (5) being incorporated in a hydraulic closed circuit which operates an electricity-generating turbine (8).

2. The power station on a submerged floating platform according to claim 1, characterized in that the electricity-generating turbine (8) is arranged in a platform (7) which is supported above the surface of the water by means of a structural assembly formed by tubular columns (6) through which the hydraulic closed circuit is determined between the pumping mechanisms (5) and the electricity-generating turbine (8).

3. The power station on a submerged floating platform according to claim 1, characterized in that the floating structure (1) has an annular polygonal shape, being made up of consecutively joined sectors (1.1), each of which consists of a tubular element closed at one end, the joined assembly of the successive sectors (1.1) forming independent leak-tight enclosures which can be filled with water or with air.

4. The power station on a submerged floating platform according to claim 1, characterized in that each pumping mechanism (5) consists of a cylindrical body (10) with respect to which a dome (11) can move axially, which dome (11) is joined to said body (10) along the contour by means of a flexible membrane (12), the dome (11) incorporating a plunger (13) moving in a cylinder (14) with respect to which the hydraulic closed circuit communicating with the electricity-generating turbine (8) is connected by means of an inlet valve (15) and an outlet valve (16), whereas between the dome (11) and the body (10) there is a chamber (17) in which the pneumatic spring system operating in the mechanism (5) acts.

5. The power station on a submerged floating platform according to claim 1, characterized in that incorporated on the platform (7) there is a wind generator (20), whereby a complement for producing electricity by the action of the wind is obtained on the same structural assembly for mounting and operating the electricity-generating turbine (8).

6. The power station on a submerged floating platform according to claim 1, characterized in that incorporated in the submerged floating structure (1) there are complementary propeller-type devices (21), whereby a complement for producing electricity by the action of the water currents is obtained on the same structural assembly for mounting and operating the electricity-generating turbine (8).

7. A power station on a submerged floating platform, of the type comprising a functional assembly incorporated in a floating structure submerged at a certain depth and moored by means of guy lines with respect to ballasts or mooring buoys located in the aquatic bed, incorporating functional means for producing electricity by the action of the waves and complementarily by the action of the wind and by the action of the water currents, characterized in that the structural assembly having the functional elements for producing electricity is joined above the water to the structural assemblies of other similar power stations by means of walkways (22) in which the power transmission lines are arranged.

8. The power station on a submerged floating platform according to claim 7, characterized in that in the arrangement of multiple power stations joined by means of walkways (22), wind generators (20) are arranged on the structural assembly of some of the power stations, respecting the necessary distance to prevent interferences between wind generators (20).
